(19) United States
(12) Patent Application Publication
(10) Pub. No.: US 2005/0210630 A1
(43) Pub. Date: Sep. 29, 2005

(54) Door hinge for motor vehicles

(75) Inventors: Jakob Lowen, Gummersbach (DE); Johann Olfert, Bergneustadt (DE)

Correspondence Address: BACHMAN & LAPOINTE, P.C., 900 CHAPEL STREET, SUITE 1201, NEW HAVEN, CT, 06510, US

(73) Assignee: ISE Innomotive Systems Europe

(21) Appl. No.: 11/077,673

(22) Filed: Mar. 10, 2005

(30) Foreign Application Priority Data
Mar. 10, 2004 (DE) 10 2004 012 006.4

(51) Int. Cl. B60J 5/00; E05D 7/08

(52) U.S. Cl. 16/379; 16/221

(57) ABSTRACT

The invention relates to a door hinge for motor vehicles, in particular for cars, with a pillar bracket which can be positioned on a vehicle and a door bracket which can be attached to the vehicle door, which are joined together by means of a hinge pin, such as to be articulated. In order to provide a door hinge which can be produced at low cost with only limited production expenditure and low weight, it is proposed that the pillar bracket and/or the door bracket (1) be produced from one sheet metal component.

### BACKGROUND OF THE INVENTION

The invention relates to a door hinge for motor vehicles, in particular for cars, with a pillar bracket which can be positioned on the vehicle and a door bracket which can be attached to the vehicle door, which are joined to one another, such as to be articulated, by means of a hinge pin.

This type of door hinge is used in particular with cars for the linkage of vehicle doors to the vehicle. In such cases, the hinge pin which joins the door bracket and the pillar bracket is mounted in one of the two brackets in such a way that it can not become distorted, and so that the relative movement of the door to the vehicle takes place by means of a relative movement of the hinge pin to the pillar bracket or the door bracket.

With established door hinges of the type specified at the outset, the door bracket and the pillar bracket are produced from rolled sections or similar. The disadvantage of these, however, is that, due to the high level of manufacturing expenditure, they can only be produced at very high cost. In addition, the door hinges produced for use with established pillar brackets and door brackets are very heavy, and this is particularly disadvantageous in view of the weight reduction which is striven after in motor vehicle construction.

With further developments of the hinges described at the outset, the pillar and/or door brackets are no longer produced from rolled sections or similar, but from forgings. However, these also have the considerable disadvantage that, due to the mostly highly complex form of the components, the forging process used to produce the components is very expensive and does not lead to any reduction in costs with regard to the components produced by casting processes.

U.S. Pat. No. 2,163,713 has already made known a door hinge of the type specified at the outset, whereby the pillar bracket and the door bracket are produced from a sheet metal component. In this instance, the hinge pin which joins the brackets, however, is mounted pivotally both in the pillar bracket and in the door bracket.

### SUMMARY OF THE INVENTION

The aim of the invention is to provide a door hinge for motor vehicles which has an insertion opening for the distortion-free positioning of a hinge pin, and which can be produced at a reasonable cost.

The invention solves the problem by means of a door hinge in accordance with claim 1. Advantageous further developments of the invention are specified in the dependent claims.

Characteristic for the door hinge in accordance with the invention is a pillar and/or door bracket produced from a sheet metal component. The advantage of the sheet metal component is that it can be produced simply by means of established and low-cost recasting processes, and so can be adapted without any problems to the specific requirements of the vehicle.

Because, in addition, one can fall back upon low-priced raw materials for production, the dimensions of which are preferably adapted to the product form, the processing expenditure when producing the sheet metal components can also be minimized.

The door hinges in accordance with the invention, produced by using sheet metal components, can thus be produced at particularly low cost, and in addition, are of low weight, and this has a positive effect upon the total weight of a vehicle provided with these door hinges.

Basically, it is possible to produce the door bracket and/or the pillar bracket from a single sheet metal component. In accordance with an advantageous further development of the invention, it is, however, proposed that the pillar and/or the door bracket is formed from two sheet metal components which are joined together, and in particular in the form of sheet metal angles.

A door hinge further developed in this way is of only low weight and is particularly very stable and solid, whereby even the production of relatively complex forms can be achieved by the combination of two sheet metal components which are easy to produce, so that essentially any required form can be produced for the pillar and/or door bracket by means of the combination of two sheet metal components, with only a limited amount of expenditure.

Because, in addition, the connection process for the sheet metal angles can be integrated without any problem into the production process, whereby two sheet metal angles which match one another can be produced, it is possible even to produce pillar and/or door brackets for the door hinge which are complex in form with very little additional expenditure and so at almost neutral cost.

The form of the sheet metal component, or the form of the two sheet metal angles, can be of basically any design, and is generally adapted to the corresponding constructional specifications which arise from the structure of the vehicle and the vehicle door. In accordance with a particularly advantageous further development of the invention, the sheet metal angles are, however, essentially turned at right angles, and they are respectively joined two-dimensionally to one another with a side-piece by means of a common contact surface.

In accordance with this further development of the invention, the sheet metal angles are respectively supported by the whole surface of a side-piece. The side-pieces of the respective sheet metal angles which are adjacent to the side-pieces making the contact then together form an essentially flush contact surface for fastening the sheet metal component to the door or the framework structure of the vehicle.

The hinge further developed in this way is thus especially appropriate to reliably transfer any forces being applied to the contact surface over the support surface to the door or the pillar.

Because both of the sheet metal angles used to form the sheet metal components can be formed in an essentially identical manner in accordance with a particularly advantageous further development of the invention, the production of a corresponding door hinge is possible at particularly low cost, because there is no need for separate production of the sheet metal angles which are to be joined together.

Connection of the sheet metal angles can basically be achieved using all of the established connection techniques, such as eg. gluing, riveting, bolting or similar. In a further embodiment of the invention, it is, however, proposed that the sheet metal angles are welded together. This type of connection represents a particularly easy and low-cost connection possibility which is particularly considered because the sheet metal components are generally not separated at a later stage.

The connection of the door bracket and the support bracket of the hinge takes place by means of a hinge pin which is mounted onto one of the brackets such that it can not be distorted and swivelling on the other bracket.

In accordance with the invention, an insertion opening is provided which guarantees that the hinge pin is positioned such that it can not become distorted.

With a corresponding form of the hinge pin and the insertion opening, the hinge pin can be located simply on the sheet metal component such that it can not become distorted, whereby all additional means can be dispensed with. The connection between the hinge pin and the insertion opening, which is generally form locked, is also characterized in that it particularly reliably prevents relative movement of the hinge pin in the insertion opening.

In accordance with a further embodiment of the invention, the insertion opening has a circular through boring which essentially extends at right angles to the contact surface of the sheet metal angle. The through boring makes it possible to fix the hinge pin simply in an axial direction to the door or pillar bracket by using corresponding fastening means, such as eg. rivets, screws or similar, which can, for example, be screwed into the hinge pin in an axial direction. Because the hinge pin is also in contact with the sheet metal angles over the whole length of the through boring, which is provided through the thickness of the sheet metal angles connected to one another, a particularly reliable and stable positioning of the hinge pin in the insertion opening is guaranteed.

In order to ensure that the hinge pin can not become distorted when located in the insertion opening, it is proposed by a further development that the insertion opening has at least one, and preferably two diametrically positioned cut-outs which extend outwards, preferably radially from the edge of the through boring. These cut-outs are designed to correspond to protrusions on the hinge pin.

This type of further development of the invention makes it possible, by means of form locking, to locate the hinge pin in the insertion opening such that it can not become distorted, in a particularly simple way. Due to the particularly simple creation of the cut-outs, the form of which can be adapted to the forces which occur, as a result of the constructional requirements, it is possible to produce the door hinge at especially low cost. Moreover, this further development also makes the particularly simple installation of the hinge pin in the insertion opening possible.

In accordance with a further embodiment of the invention, the cut-out—viewed in the direction in which the hinge pin is pushed into the sheet metal component—is tapering in form. By means of this further development of the invention, it can be particularly reliably guaranteed that the hinge pin is located in the insertion opening without any play, so that undesirable relative movements or play on the door hinge which leads to the door not being leak-proof can be effectively avoided.

The tapered form of the cut-outs can basically be in any form. In accordance with an advantageous further development of the invention, the cut-out does, however, have a trapezoid cross-section—as viewed at right angles to the axis of the through boring. It is particularly easy to create this type of cut-out, as it is to create the corresponding protrusions on the hinge pin.

Moreover, because just a small curve of the angular faces of the trapezium is sufficient in order to guarantee an arrangement without any play, during operation only a small component of force is effective in the direction of the hinge pin axis, so that accidental separation of the hinge, for example caused by lifting of the door bracket from the support bracket, is effectively prevented.

In accordance with a further embodiment of the invention, the sheet metal component used around the insertion opening is hardened, and in particular hardened on the surface. The hardening makes it possible, in addition, to prevent plastic distortion of the insertion opening and wear and tear in the insertion opening. The surface hardening, whereby only a small amount of heat is introduced into the sheet metal component, makes it possible to achieve hardening without extensive structural changes to the sheet metal component, so that the positive material properties of the sheet metal component can be maintained.

### BRIEF DESCRIPTION OF THE DRAWINGS

In accordance with the invention, the insertion opening is created by stamping the sheet metal component. The stamping process can easily be integrated into the continuous production process, so that it is possible to produce a sheet metal component with a cut-out at low cost.

In the following, an embodiment of the invention is described with reference to the drawings. In the drawings:

FIG. 1 shows a perspective view of a door bracket in the form of a sheet metal component with a correspondingly formed hinge pin;

FIG. 2 shows a side view of the door bracket and the hinge pin from FIG. 1 with a sectional view through an insertion opening for the hinge pin and

FIG. 3 shows a blown-up representation of the door bracket from FIG. 1.

### DETAILED DESCRIPTION

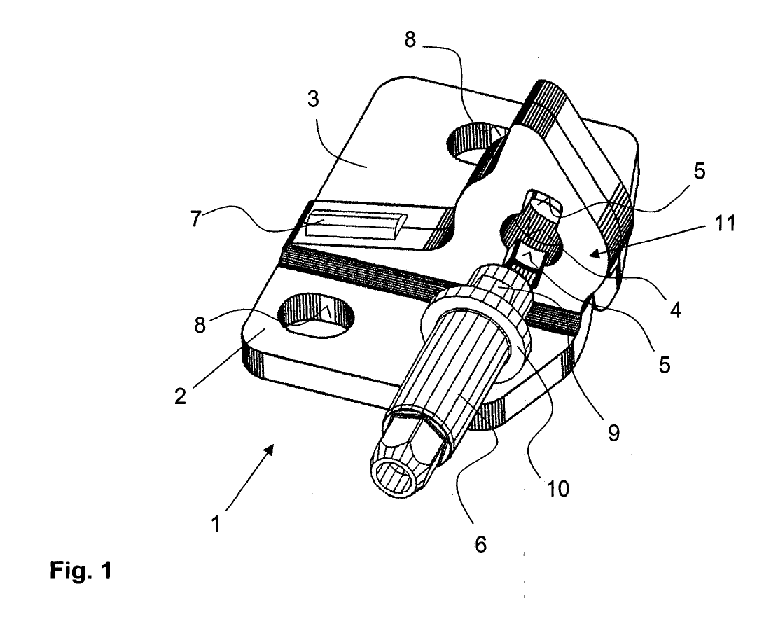

In FIG. 1 a door bracket 1 made from two sheet metal angles 2, 3 is shown, which is connected by means of a hinge pin 6, which in assembled state is located in the insertion opening 11, to a pillar bracket (not illustrated here).

The sheet metal angles 2, 3, which are turned at right angles, are connected to one another by means of a welded seam 7 via essentially congruent surfaces, facing one another, of a respective side-piece.

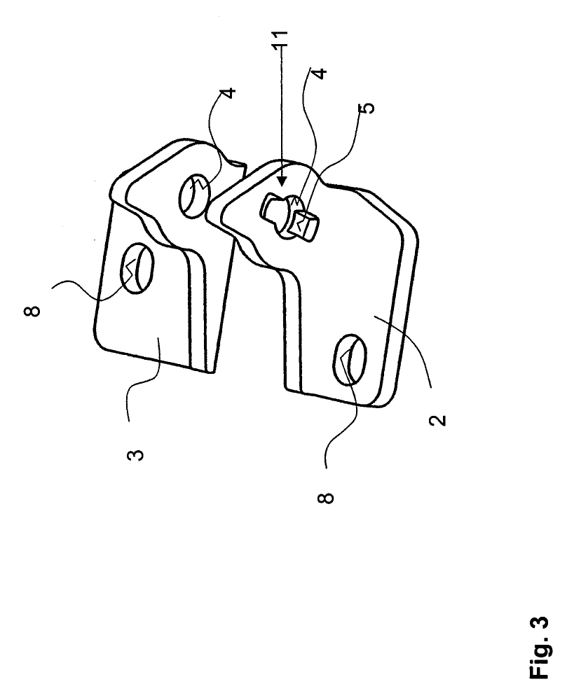

The side-pieces of the sheet metal angles 2, 3 adjacent to the contact surfaces form a flush contact surface into which respectively a fastening hole 8 is provided, which is designed for the insertion of corresponding screws, by means of which the door bracket 1 can be fastened to a vehicle door (not illustrated here) (see FIG. 3).

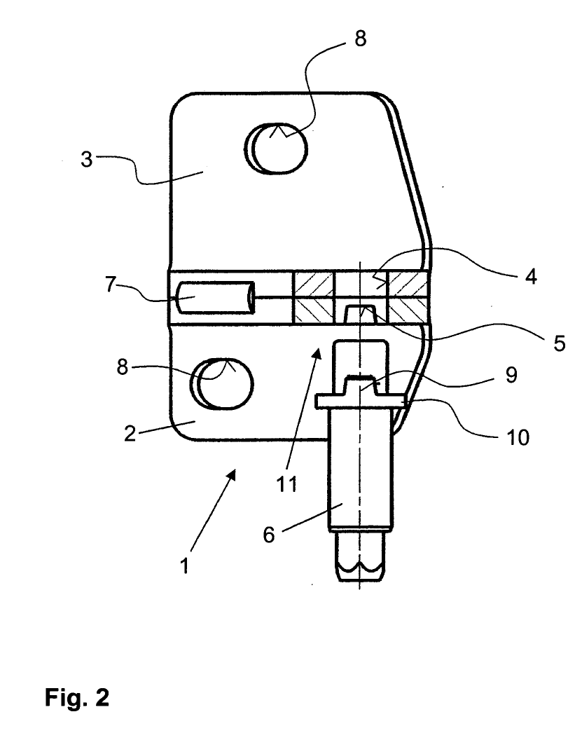

The insertion opening 11 for the insertion of the hinge pin 6 is located in the connecting section of the two sheet metal angles 2, 3 and has a through boring 4 which extends at right angles to the side-pieces of the sheet metal angles 2, 3 making contact, and has a diameter which corresponds to the diameter of the hinge pin 6 in the connecting section (see FIG. 2).

In the section facing the hinge pin 6, the insertion opening 11 has two diametrically located trapezoid cut-outs 5 which extend outwards radially from the through boring 4, and which are provided so that corresponding protrusions 9 can engage onto the hinge pin 6 without any play.

These protrusions 9 are adjacent to an annular ring 10 on the hinge pin 6, which in assembled state lies on the edge of the insertion opening 11 so that the hinge pin 6 is fastened in an axial direction.

When attaching the vehicle door to the vehicle (not illustrated here either), the vehicle door, with the door bracket 1 attached to it, is placed onto an upwardly extending hinge pin 6 from one of the pillar brackets fastened onto the vehicle. So as to secure the vehicle door in place, a screw is then screwed in the axial direction of the hinge pin 6 through the through boring 4 into the end of the hinge pin 6 facing the door bracket 1, whereby a screw head of the screw lies around the through boring on the door bracket 1.

1. Door hinge for motor vehicles, in particular for cars, comprising:
a pillar bracket which can be positioned on the vehicle and
a door bracket which can be attached to the vehicle door, and a hinge pin for joining the pillar bracket and the door bracket in an articulated manner, wherein the pillar bracket and/or the door bracket (1) are produced from a sheet metal component, and wherein the pillar bracket or the door bracket (1) has an insertion opening (11) for inserting the hinge pin (6) designed such that it can not become distorted, whereby the insertion opening (11) is produced by stamping the sheet metal component.

2. Door hinge in accordance with claim 1, wherein the door bracket (1) and/or the pillar bracket is formed from two sheet metal components connected to one another, in particular as sheet metal angles (2, 3).

3. Door hinge in accordance with claim 2, wherein the sheet metal angles (2, 3) are essentially turned at right angles and are connected to one another two-dimensionally over a common contact surface with a respective side piece.

4. Door hinge in accordance with claim 2, wherein the sheet metal angles (2, 3) are welded together.

5. Door hinge in accordance with claim 2, wherein the insertion opening (11) has a circular through boring (4) which essentially extends at right angles to the contact surface of the sheet metal angles (2, 3).

6. Door hinge in accordance with claim 5, wherein the insertion opening (11) has at least one diametrically positioned cut-out (5) which extends outwardly from the edge of the through boring (4).

7. Door hinge in accordance with claim 5, wherein the insertion opening has two diametrically positioned cut-outs which extend outwardly from the edge of the through boring.

8. Door hinge in accordance with claim 6, wherein the at least one cut-out extends radially from the edge of the through boring.

9. Door hinge in accordance with claim 1, wherein the cut-outs (5) are tapered, as viewed in the direction in which the hinge pin (6) is pushed into the door bracket (1).

10. Door hinge in accordance with claim 1, wherein the cut-out, viewed at right angles to the axis of the through boring (4) has a trapezoid cross section.

11. Door hinge in accordance with claim 1, wherein the sheet metal component is hardened around the insertion opening (11), and in particular hardened on the surface.

12. Door hinge in accordance with claim 1, wherein the door bracket is produced from one sheet metal component.
